(19) United States
(12) Patent Application Publication
(10) Pub. No.: US 2014/0371888 A1
(43) Pub. Date: Dec. 18, 2014

(54) CHOOSING OPTIMAL AUDIO SAMPLE RATE IN VOIP APPLICATIONS

(71) Applicant: Tomas LUNDQVIST, Segeltorp (SE)

(72) Inventor: Tomas LUNDQVIST, Segeltorp (SE)

(21) Appl. No.: 13/207,104

(22) Filed: Aug. 10, 2011

(51) Int. Cl. G06F 17/00

(52) U.S. Cl. 700/94

(57) ABSTRACT

Methods and systems for selecting audio recording and playout sample rates for a media device so as to optimize performance of audio processing components of the device. Audio recording and playout sample rates are selected using an algorithm based on a prioritized set of factors and the particular characteristics and capabilities of an applicable audio device. The factors considered when selecting recording and playout sample rates carry an assigned weight or priority with respect to one another such that the sample rates are selected to improve the audio quality processing and performance on a given device.

### FIELD OF THE INVENTION

The present disclosure generally relates to systems and methods for transmission of audio signals such as voice communications. More specifically, aspects of the present disclosure relate to determining sample rates for audio recording and playout.

### BACKGROUND

Voice Over Internet Protocol (VoIP) applications for personal computers (PCs) and mobile devices (e.g., “smart” phones, personal digital assistants, tablet computers, etc.) typically record audio (e.g., speech, music, etc.) from a microphone and playout audio through a speaker by communicating with an audio device via an audio interface implemented by device driver software. Different audio devices and drivers support different sample rates and the same sample rates are not always supported for recording and playout functionality. For example, recording sometimes supports a lower sample rate than playout, especially on mobile telephones.

### SUMMARY

This Summary introduces a selection of concepts in a simplified form in order to provide a basic understanding of some aspects of the present disclosure. This Summary is not an extensive overview of the disclosure, and is not intended to identify key or critical elements of the disclosure or to delineate the scope of the disclosure. This Summary merely presents some of the concepts of the disclosure as a prelude to the Detailed Description provided below.

One embodiment of the present disclosure relates to a method for selecting sample rates for audio recording and playout on an audio device, the method comprising: selecting a first recording sample rate of a plurality of recording sample rates for recording audio on the device; determining the device supports the first recording sample rate; and responsive to determining the device supports the first recording sample rate, selecting a playout sample rate based on the first recording sample rate.

In another embodiment, the playout sample rate is one of a plurality of playout sample rates, and the step of selecting the playout sample rate based on the first recording sample rate includes: identifying one or more playout sample rates of the plurality of playout sample rates as a multiple of the first recording sample rate; selecting a highest of the one or more identified playout sample rates; and determining the device supports the highest of the one or more playout sample rates.

In another embodiment, the method for selecting sample rates for audio recording and playout further comprises: in response to determining the device does not support the highest of the one or more playout sample rates, selecting a next highest playout sample rate of the one or more playout sample rates.

In still another embodiment, the method for selecting sample rates for audio recording and playout further comprises: in response to determining the device does not support the first recording sample rate, selecting a second recording sample rate of the plurality of recording sample rates, wherein the second recording sample rate is less than the first recording sample rate; and in response to determining the device supports the second recording sample rate, selecting a playout sample rate based on the second recording sample rate.

In another embodiment, the step of selecting the playout sample rate based on the first recording sample rate includes: determining whether the first recording sample rate is greater than or equal to a threshold sample rate; in response to determining the first recording sample rate is greater than or equal to the threshold sample rate, selecting a playout sample rate equal to the first recording sample rate; and in response to determining the first recording sample rate is not greater than or equal to the threshold sample rate, selecting a multiple of the first recording sample rate as the playout sample rate, wherein the multiple of the first recording sample rate is greater than or equal to the threshold sample rate.

Another embodiment of the present disclosure relates to a method for determining audio recording and playout sample rates, the method comprising: selecting a first recording sample rate of a plurality of recording sample rates for recording audio on an audio device; determining whether the audio device supports the first recording sample rate; in response to determining the audio device supports the first recording sample rate, selecting a playout sample rate based on the first recording sample rate; in response to determining the audio device does not support the first recording sample rate, selecting a second recording sample rate of the plurality of recording sample rates, wherein the second recording sample rate is less than the first recording sample rate; and in response to determining the audio device supports the second recording sample rate, selecting the playout sample rate based on the second recording sample rate.

Another embodiment of the present disclosure relates to a system for selecting sample rates for audio recording and playout, the system comprising an audio device configured to record audio using one or more of a plurality of recording sample rates and playout audio using one or more of a plurality of playout sample rates, and an audio device driver in communication with the audio device, the audio device driver configured to: select a first recording sample rate of the plurality of recording sample rates; determine the audio device supports the first recording sample rate; and in response to determining the audio device supports the first recording sample rate, select a playout sample rate of the plurality of playout sample rates based on the first recording sample rate.

In another embodiment, the system for selecting sample rates for audio recording and playout further comprises an audio input device for capturing audio to be recorded on the audio device, and an audio output device for playing audio recorded on the audio device.

In yet another embodiment, the audio device driver of the system for selecting sample rates for audio recording and playout is further configured to select the first recording sample rate as the playout sample rate.

In another embodiment, the audio device driver of the system for selecting sample rates for audio recording and playout is further configured to select a multiple of the first recording sample rate as the playout sample rate.

In still another embodiment, the audio device driver of the system for selecting sample rates for audio recording and playout is further configured to: identify one or more of the plurality of playout sample rates as a multiple of the first recording sample rate; select a highest of the one or more identified playout sample rates; and determine the audio device supports the highest of the one or more identified playout sample rates.

In still another embodiment, the audio device driver of the system for selecting sample rates for audio recording and playout is further configured to, in response to determining the audio device does not support the highest of the one or more identified playout sample rates, select a next highest playout sample rate of the one or more identified playout sample rates.

In still another embodiment, the audio device driver of the system for selecting sample rates for audio recording and playout is further configured to: in response to determining the audio device does not support the first recording sample rate, select a second recording sample rate of the plurality of recording sample rates, wherein the second recording sample rate is less than the first recording sample rate; and in response to determining the audio device supports the second recording sample rate, select a playout sample rate of the plurality of playout sample rates based on the second recording sample rate.

In still another embodiment, the audio device driver of the system for selecting sample rates for audio recording and playout is further configured to: determine whether the first recording sample rate is greater than or equal to a threshold sample rate; and in response to determining the first recording sample rate is not greater than or equal to the threshold sample rate, select a multiple of the first recording sample rate as the playout sample rate, wherein the multiple of the first recording sample rate is greater than or equal to the threshold sample rate.

In other embodiments of the disclosure, the methods and systems described herein may optionally include one or more of the following additional features: the selected playout sample rate is the same as the first recording sample rate; the selected playout sample rate is a multiple of the first recording sample rate; the threshold sample rate is one of 16 kHz and 32 kHz; and/or each of the first recording sample rate and the selected playout sample rate is a multiple of 8 kHz.

Further scope of applicability of the present invention will become apparent from the Detailed Description given below. However, it should be understood that the Detailed Description and specific examples, while indicating preferred embodiments of the invention, are given by way of illustration only, since various changes and modifications within the spirit and scope of the invention will become apparent to those skilled in the art from this Detailed Description.

### BRIEF DESCRIPTION OF DRAWINGS

These and other objects, features and characteristics of the present disclosure will become more apparent to those skilled in the art from a study of the following Detailed Description in conjunction with the appended claims and drawings, all of which form a part of this specification. In the drawings:

FIG. 1 provides a general description of a representative embodiment in which one or more aspects described herein may be implemented.

FIG. 2 is a functional block diagram illustrating an example audio interface module according to one or more embodiments described herein.

FIG. 3 is a flowchart illustrating an example method for selecting audio recording and playout sample rates according to one or more embodiments described herein.

FIG. 4 is a flowchart illustrating an example method for selecting audio recording and playout sample rates based on threshold requirements according to one or more embodiments described herein.

FIG. 5 is a flowchart illustrating an example method for selecting audio recording and playout sample rates for a set of audio codecs according to one or more embodiments described herein.

FIG. 6 is a block diagram illustrating an example computing device arranged for multipath routing and processing of audio input signals according to one or more embodiments described herein.

The headings provided herein are for convenience only and do not necessarily affect the scope or meaning of the claimed invention.

In the drawings, the same reference numerals and any acronyms identify elements or acts with the same or similar structure or functionality for ease of understanding and convenience. The drawings will be described in detail in the course of the following Detailed Description.

### DETAILED DESCRIPTION

Various examples of the invention will now be described. The following description provides specific details for a thorough understanding and enabling description of these examples. One skilled in the relevant art will understand, however, that the invention may be practiced without many of these details. Likewise, one skilled in the relevant art will also understand that the invention can include many other obvious features not described in detail herein. Additionally, some well-known structures or functions may not be shown or described in detail below, so as to avoid unnecessarily obscuring the relevant description.

Differences in recording and playout sample rates across different audio devices and within the same audio device impact other features and functionalities related to audio transmission and processing. For example, differences in recording and playout sample rates affect various audio quality improvement processing that operates on both recorded data and data to be played out, such as acoustic echo control (AEC) and acoustic echo suppression (AES).

As with other audio quality improvement processing, AEC and AES often work better when the same sample rate is used for both audio recording and audio playout. Additionally, for the benefits of wideband audio codecs to be realized, a sample rate of at least 16 kHz should be used for any transmission direction that supports it. As such, in some scenarios the benefits of using the same sample rate in both directions (e.g., recording and playout) of audio transmission may be outweighed by the benefits of having a playout sample rate of at least 16 kHz.

One or more embodiments of the present disclosure relate to methods and systems for selecting audio recording and playout sample rates for an audio device based on factors particular to the device and a priority of requirements. The factors and requirements considered when selecting recording and playout sample rates may each carry a weight or priority with respect to one another such that the sample rates selected improve audio processing and performance for a particular device.

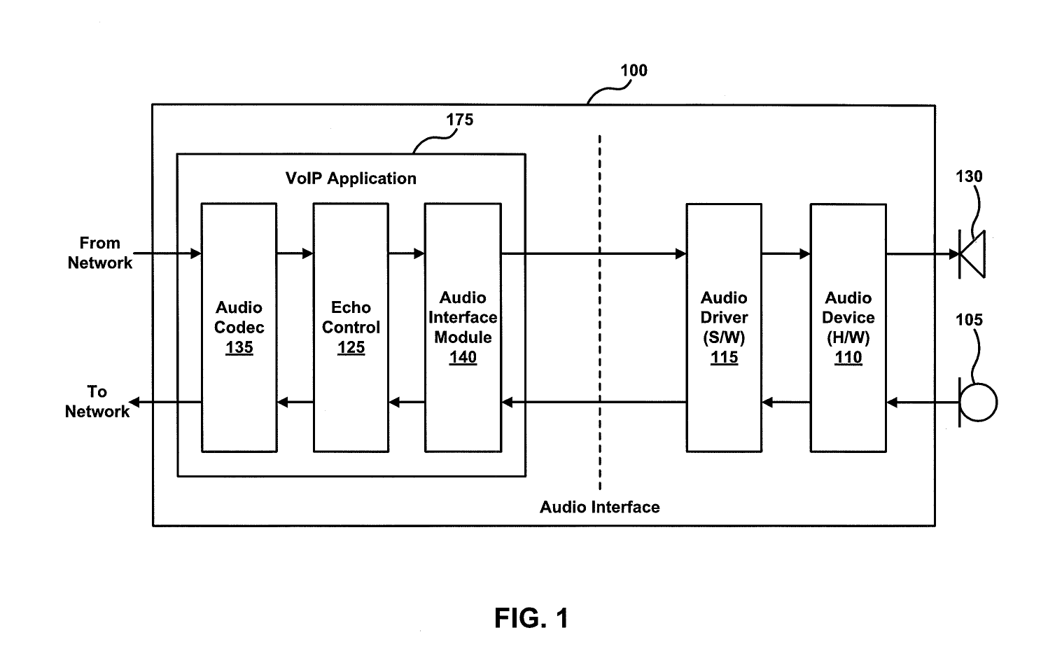

FIG. 1 and the following discussion provide a brief, general description of a representative embodiment in which various aspects of the present disclosure may be implemented. As shown in FIG. 1, a media device 100 (e.g., a mobile telephone, media player, personal computer (PC), television, etc.) may include a capture device 105 and a render device 130 for recording and playing out, respectively, audio such as music, voice, etc. In some arrangements, media device 100 may be one component in a larger system for communications (e.g., voice or data communications). The media device 100 may be an independent component in such a larger system or may be a subcomponent within an independent component (not shown) of the system.

In the example embodiment illustrated in FIG. 1, the media device 100 includes a Voice-Over-Internet-Protocol (VoIP) application 175 running on top of the operating system (not shown) of the media device. The VoIP application 175 is configured to communicate over an audio interface (denoted by the dotted line) with the operating system which, in turn, uses an audio driver 115 to communicate with an audio device 110 to capture and render audio through the capture device 105 and render device 130, respectively. In at least some embodiments, the VoIP application 175 is configured to process audio signals through various audio enhancement processing (e.g., echo cancellation or suppression, noise suppression, etc.) and encode and packetize the audio signals for transmission as digitized data packets over a packet-switched network (e.g., an Internet Protocol (IP) network). The media device includes audio device hardware (H/W) 110 (e.g., a soundcard) and audio driver software (S/W) 115 (which is a part of the operating system), for converting audio signals from analog-to-digital (e.g., at the near-end from capture device 105) and digital-to-analog (at the far-end to render device 130).

Capture device 105 may be any of a variety of audio input devices, such as one or more microphones configured to capture sound and generate input signals. Render device 130 may be any of a variety of audio output devices, including a loudspeaker or group of loudspeakers configured to output sound of one or more channels. For example, capture device 105 and render device 130 may be hardware devices internal to media device 100 (e.g., a computer system), or external peripheral devices connected to the media device 100 via wired and/or wireless connections. In some arrangements, capture device 105 and render device 130 may be components of a single device, such as a speakerphone, telephone handset, etc., depending on the particular characteristics of the media device 100. Additionally, one or both of capture device 105 and render device 130 may include analog-to-digital and/or digital-to-analog transformation functionalities, which may be an alternative to such functionalities being part of the audio device H/W 110 and audio driver S/W 115.

VoIP Application 175 may include an audio interface module 140, echo control component 125, and audio codec 135. Audio interface module 140 may be configured to receive an audio signal communicated over the audio interface between the VoIP application 175 and the operating system of the media device 100. As will be described in greater detail below, one or more embodiments of the present disclosure provide a sample rate selection algorithm that is implemented to select sample rates for use with audio communicated over the audio interface. In some embodiments, audio interface module 140 may also be configured to generate output to other types of audio processing components in addition to, or instead of, echo control 125. For example, in other arrangements the audio device module 140 may be configured to output signals to automatic gain control (AGC) components, noise suppression (NS) components, and/or other audio quality improvement components (not shown). In some embodiments, these other processing components may receive audio input communicated over the audio interface prior to the audio device module 140 receiving such input.

The audio interface indicated by the dotted line in FIG. 1 is the interface between the VoIP application 175 and the operating system of the media device 100, which includes the audio driver 115. The various embodiments described herein relate to a sample rate selection algorithm implemented within the audio interface module 140 to select recording and playout sample rates used for audio communicated over the audio interface (e.g., audio communicated to and from the VoIP application 175). The audio interface module 140 calls audio interface API functions exposed by the operating system of the media device 100, which in turn queries or configures settings in the audio driver 115. The query response may reflect audio driver and/or hardware capabilities and the settings may be applied to the audio driver software 115 or the hardware 110. As such, the audio interface module 140 selects the sample rates to be used over the audio interface based on what the audio driver software 115 and/or audio device hardware 110 can support.

Echo control component 125 may include various types of acoustic echo control systems, modules, units, components, etc., including acoustic echo cancellers and/or suppressors. In at least one example, the echo control 125 may be an acoustic echo canceller or suppressor configured to cancel and/or suppress acoustic echo for voice and audio communications. Additionally, the echo control 125 may be configured to operate on a signal (e.g., cancel or suppress echo in the signal) in time-domain or frequency-domain, and may be located in end-user equipment, including a computer system, wired or wireless telephone, voice recorder, and the like.

In other embodiments of the present disclosure, one or more other components, modules, units, etc., may be included as part of the media device 100, in addition to or instead of those illustrated in FIG. 1. Furthermore, the names used to identify the units and components included as part of the media device 100 (e.g., “audio interface module”) are exemplary in nature, and are not in any way intended to limit the scope of the disclosure.

Additionally, the components shown in FIG. 1 may form one or more parts of an end-user media device, or may be contained in separate units or parts of such an end-user media device. Examples of such media devices include mobile telephones, portable radios, media players, sound and/or video recorders, personal computers, televisions, personal digital assistants (PDAs), etc. Media devices may also include numerous types of wireless handheld devices, personal computers, and similar devices capable of recording and playing audio.

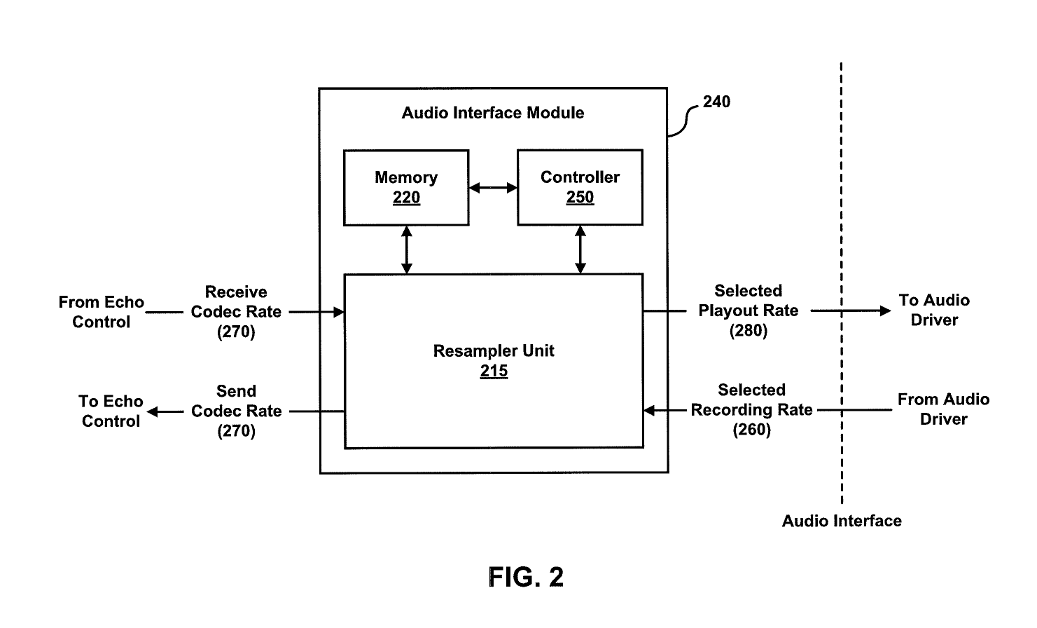

FIG. 2 illustrates an example audio interface module (e.g., audio interface module 140 shown in FIG. 1) showing audio signal flows according to one or more embodiments described herein. In at least the embodiment shown in FIG. 2, the audio interface module 240 includes a controller 250 for coordinating various processes performed therein, and monitoring and/or adapting timing considerations for such processes. Audio interface module 240 may be a component of a VoIP application (e.g., VoIP application 175 shown in FIG. 1) and further include a resampler unit 215 and a memory 220. Each of the resampler unit 215 and the memory 220 may be in communication with the controller 250 such that the controller 250 facilitates some of the processes performed by and between these components. Details of the controller 250, the resampler unit 215, and the memory 220 will be further described below.

Controller 250 may be any of a variety of central processing units or programmable processors that may be configured to control communications between the various components (e.g., the resampler unit 215, the memory 220, etc.) of the audio interface module 240 and manage the passing of signals and other information between the audio interface module 240 and other components in the signal chain (e.g., echo control component 125 shown in FIG. 1) as described herein. For example, the controller 250 may direct the resampler unit 215 to translate between the sample rates selected for audio communicated over the audio interface (sometimes referred to herein as the “audio interface sample rates”) and sample rate of the audio codec used (e.g., audio codec 135 used in VoIP application 175 shown in FIG. 1). Additionally, the controller 250 may communicate to the resampler unit 215 feedback information received at the audio interface module 240 from various other components of a VoIP application (e.g., echo control component 125 and/or audio codec 135 of VoIP application 175 shown in FIG. 1) and/or components of an operating system of a media device (e.g., media device 100 shown in FIG. 1), such as an audio driver (e.g., audio driver 115 shown in FIG. 1). In at least some arrangements, the controller 250 handles timing considerations for the translation of sample rates selected by an algorithm for an audio interface to the sample rate of an applicable audio codec by resampler unit 215. Additionally, the controller 250 also coordinates the exchange of information between other components of the VoIP application and/or the audio device operating system and memory 220 and/or resampler unit 215 while such an algorithm is running.

In one or more other embodiments of the present disclosure, one or more other components, modules, units, etc., may be included as part of audio interface module 240, in addition to or instead of those illustrated in FIG. 2. Furthermore, the units and components included as part of audio interface module 240 (e.g., “resampler unit”) are exemplary in nature, and are not in any way intended to limit the scope of the disclosure.

As will be further described below, embodiments of the present disclosure relate to methods and systems for selecting audio recording and playout sample rates for audio communicated over an audio interface between an operating system of a media device and a VoIP application running on the device. An algorithm is used to select the recording and playout sample rates based on a number of different requirements and/or factors specific to a given media device. These requirements and/or factors may each be assigned a priority or weight in relation to one another such that certain requirements and/or factors are more or less determinative in selecting recording and playout sample rates than others for a given media device.

Some examples of requirements and/or factors that may be used in an algorithm for selecting recording and playout sample rates for audio communicated over an audio interface of a media device include:

1. Select both recording and playout sample rates as integer multiples of eight kilohertz (8 kHz) to improve performance of audio processing components (e.g., echo control component 125 shown in FIG. 1) that operate on both recorded data and data to be played out. For example, where the selected recording and playout sample rates are not integer multiples of eight, there may be a clock drift between the two transmission directions resulting in deteriorated echo control processing.

2. Select recording and playout sample rates capable of supporting use of wideband audio codecs. Where a selected recording or playout sample rate is lower than a sample rate capable of supporting wideband audio codecs (e.g., 16 kHz), then the full bandwidth of the audio codec will not be utilized, resulting in decreased audio playout quality.

3. Select a playout sample rate capable of supporting use of super-wideband audio codecs. Where a selected playout sample rate is lower than a sample rate capable of supporting super-wideband audio codecs (e.g., 32 kHz), then the full bandwidth of the audio codec will not be utilized, resulting in decreased audio playout quality.

4. Select the highest recording and playout sample rates supported by the audio device. In some audio devices, selecting the highest-supported recording and playout sample rates reduces latency and eliminates conversion in an audio driver of the device. Sample rate conversion in the audio driver introduces additional processing complexity (e.g., CPU usage) and latency. The highest sample rate available for a given audio driver is generally equal to the native sample rate of the corresponding hardware. Using this sample rate will help eliminate conversion in the device driver. If the audio device driver has a fixed buffer size, then using the highest available sample rate for either transmission direction will result in the lowest latency.

5. Select recording and playout sample rates that are each a multiple of 8 kHz to have the best possible performance of any sample rate conversion that is necessary. Audio codecs use a sample rate that is a multiple of 8 kHz. Therefore, if either the audio recording or playout sample rate is not a multiple of 8 kHz, it is not possible to convert the sample rate without introducing a clock drift.

The requirements and/or factors described above constitute only an example set of requirements and/or factors that may be used to select sample rates according to various embodiments of the present disclosure. It should be understood that numerous other requirements and/or factors, as well as other sets or groupings of such requirements and/or factors, may similarly be used in addition to or in place of those described. Furthermore, the requirements and/or factors described above may be prioritized in various other ways depending on the particular characteristics, functions, limitations, and features of the audio device being used and/or aspects related to the environment in which the audio device is being used.

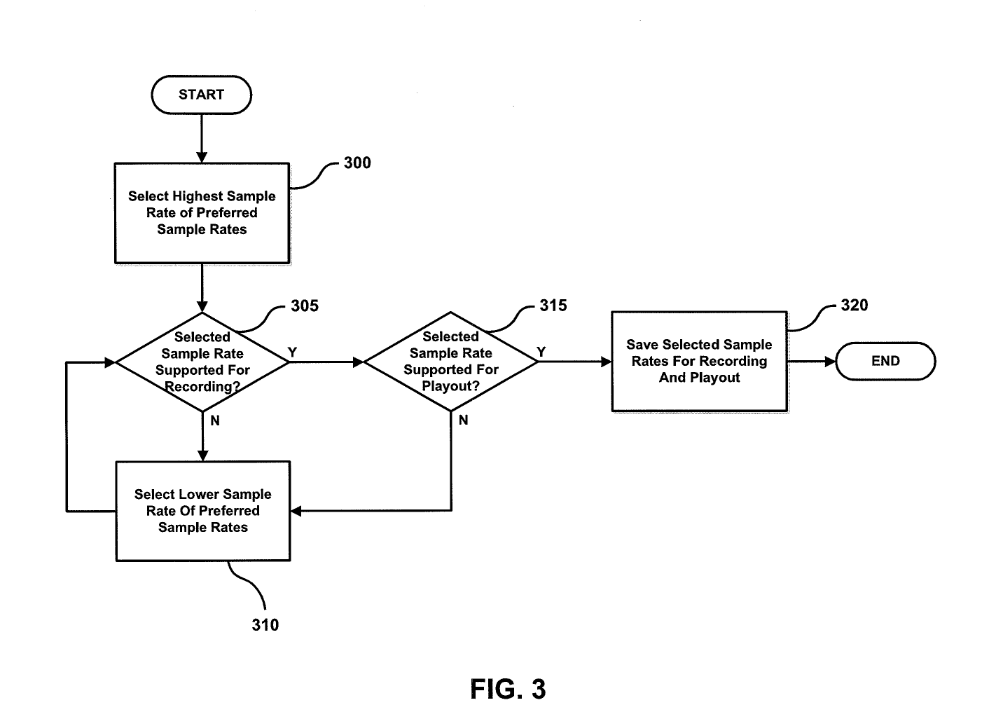

FIG. 3 illustrates a method for selecting sample rates for audio recording and playout with a priority of selecting sample rates that are the same. The sample rate selection algorithm illustrated in FIG. 3 may be used, for example, when there is audio processing in place that operates on both recorded audio data and audio data to be played out (e.g., echo control component 125 shown in FIG. 1). Such audio processing may be improved where the same sample rate is used for both audio recording and playout on a given device. In at least one embodiment of the present disclosure, the process illustrated in FIG. 3 is implemented to select recording and playout sample rates for audio that is communicated over the audio interface between an operating system (OS) of a media device and a VoIP application running on top of the OS (e.g., the audio interface (represented as a dotted line) between VoIP application 175 and audio driver 115 shown in FIG. 1).

At step 300, the process (e.g., sample rate selection algorithm) selects the highest sample rate of preferred sample rates. In at least some arrangements, the preferred sample rates include 48 kHz and 44.1 kHz, while in other arrangements the set of preferred sample rates may also include lower rates, such as 32 kHZ or even 16 kHz. In still further arrangements, the set of preferred sample rates may also include 8 kHz, as this is the lowest rate that can be used for an audio codec. In step 305 it is determined whether the audio driver (e.g., audio driver S/W 115 shown in FIG. 1) supports the selected sample rate for recording audio. The audio driver can limit the sample rates to be lower than what the corresponding audio device (e.g., audio device H/W 110 shown in FIG. 1) is capable of supporting and can also decide to support higher rates than what the audio device is able to support. As such, in step 305 it is determined whether the selected sample rate is supported by the audio driver. In at least one embodiment, this determination is made by setting the selected sample rate and testing whether an application programming interface (API) of an audio driver (e.g., audio driver 115 shown in FIG. 1) reports an error indicating that the rate is not supported. In other embodiments, the audio interface module (e.g., audio interface module 140 shown in FIG. 1), which implements the selection algorithm, may query the API to determine whether the selected sample rate for recording is supported. The determination as to whether the selected playout sample rate is supported is made in a similar manner (e.g., by testing the selected playout rate using the API of the audio driver or having the audio interface module query the API as to whether the selected playout sample rate is supported).

As described above, different audio devices support different sample rates depending on various functionalities and features built into the devices. In one scenario, capture and render hardware (e.g., capture device 105 and render device 130 shown in FIG. 1) may be separate hardware units or components of a media device, and therefore support different sampling rates. For example, a mobile telephone may only support 8 kHz recording (e.g., for making telephone calls) while supporting 44.1 kHz playout (e.g., high-quality music). In another example, the capture and render hardware may support the same maximum sample rate, but the corresponding audio driver software is only capable of converting to/from certain rates. Furthermore, the audio driver software (e.g., audio driver S/W 115 shown in FIG. 1) may support a lower maximum rate for third-party applications. In a scenario involving a personal computer, the recording or capture device may be a USB camera while the playout or render device is a soundcard built into the computer. As such, different sample rates may be supported by each of the different device types.

If it is determined in step 305 that the selected sample rate is not supported by the audio driver, then in step 310 a lower sample rate of the preferred sample rates is selected, and the process returns to step 305 where the lower sample rate is evaluated for audio driver supportability.

If the sample rate selected in either of step 300 or 310 is determined to be supported by the audio driver in step 305, then the process continues to step 315, where it is determined whether the selected sample rate is supported for playout by the audio driver. The determination as to whether the selected sample rate for playout is supported by the audio driver may be made in a manner similar to that of determining whether the selected recording sample rate is supported in step 305 (e.g., by testing the selected playout rate using the API of the audio driver or having the audio interface module query the API as to whether the selected playout sample rate is supported).

As described above, the example method for determining sample rates illustrated in FIG. 3 prioritizes selecting recording and playout sample rates that are the same over selecting sample rates in a different relationship with one another. One of several reasons for prioritizing such a requirement may be to improve performance of any audio processing involving both recorded data and data to be played out (e.g., AEC, AES, etc.). For example, echo control processing performed on recorded and playout audio data (e.g., by echo control component 125 shown in FIG. 1) may be improved by selecting sample rates that are the same.

If it is determined in step 315 that the sample rate selected for recording is also supported by the audio driver for playout, then in step 320 the selected sample rates are stored (e.g., in memory 220 shown in FIG. 2) for use when the recording and playout functions are initiated. However, if it is instead determined in step 315 that the sample rate selected for recording is not supported by the audio driver for playout, then the process returns to step 310 where a lower sample rate of the preferred sample rates is selected and then tested for recording supportability in step 305. In some cases, a particular audio driver may not support the same sample rates for both recording and playout. For example, as described above, on various mobile telephones the sample rates supported for recording audio are sometimes lower than the sample rates supported for audio playout. The opposite may be true for other types of audio devices.

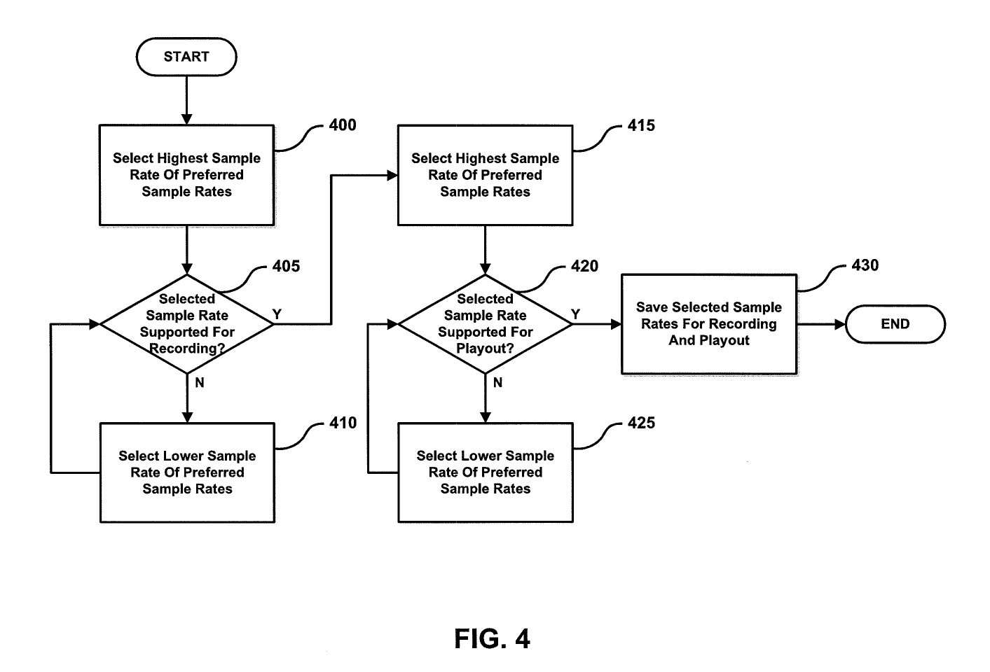

FIG. 4 illustrates a method for selecting sample rates for audio recording and playout with a priority of selecting the highest sample rates supported by the audio driver (e.g., audio driver 115 shown in FIG. 1). The sample rate selection algorithm illustrated in FIG. 4 may be used, for example, when it desired to reduce latency and eliminate conversion in the audio driver as much as possible. Sample rate conversion in the audio driver introduces additional processing complexity (e.g., CPU usage) and latency. The highest sample rate available for a given audio driver is generally equal to the native sample rate of the corresponding hardware (e.g., audio device H/W 110 shown in FIG. 1). Using such a sample rate will significantly reduce or even eliminate conversion in the audio device driver. If the audio device driver has a fixed buffer size, then using the highest available sample rate for audio transmitted in either direction will result in the lowest latency.

Similar to the sample rate selection process illustrated in FIG. 3 and described above, in at least one embodiment of the present disclosure the sample rate selection algorithm illustrated in FIG. 4 is implemented to select recording and playout sample rates for audio communicated over the audio interface between an OS of a media device and a VoIP application running on top of the OS (e.g., the audio interface between VoIP application 175 and audio driver 115 shown in FIG. 1, where the audio interface is represented as a dotted line).

The process begins at step 400, where the algorithm selects the highest sample rate of preferred sample rates. The preferred sample rates used for selection in step 400 may include any combination of 8 kHz, 16 kHz, 32 kHz, 48 kHz and 44.1 kHz, depending on the particular implementation. In step 405 it is determined whether the audio driver (e.g., audio driver S/W 115 shown in FIG. 1) supports the selected sample rate for recording audio. As with the selection algorithm illustrated in FIG. 3 and described above, in one or more embodiments of the disclosure the determination made in step 405 is performed by setting the selected sample rate and testing whether an API of the audio driver reports an error indicating the rate is not supported. In one or more other embodiments, an audio interface module (e.g., audio interface module 140 shown in FIG. 1) implementing the selection algorithm may query the API to determine whether the sample rate selected for recording is supported. The determination as to whether the selected playout sample rate is supported (step 420, which is further described below) is made in a similar manner (e.g., by testing the selected playout rate using the API of the audio driver or having the audio interface module query the API as to whether the selected playout sample rate is supported).

If it is determined in step 405 that the selected sample rate for recording is not supported by the audio driver, then in step 410 a lower sample rate of the preferred sample rates from step 400 is selected, and the process returns to step 405 where the lower sample rate is evaluated for audio driver supportability.

If the sample rate selected for recording audio in either of step 400 or 410 is determined to be supported by the audio driver in step 405, then the process moves to step 415, where the algorithm again selects the highest sample rate of the preferred sample rates from step 400. Similar to the selection of a recording sample rate, the preferred sample rates used for selection of the playout sample rate in step 415 may include any combination of 8 kHz, 16 kHz, 32 kHz, 48 kHz and 44.1 kHz, depending on the particular implementation. In step 420 it is determined whether the audio driver supports the selected sample rate for audio playout. As described above, the determination as to whether the selected sample rate for playout is supported by the audio driver may be made in a manner similar to that of determining whether the selected recording sample rate is supported in step 405. For example, step 420 may be performed by testing the selected playout rate using the API of the audio driver or having the audio interface module query the API as to whether the selected playout sample rate is supported.

If it is determined in step 420 that the selected playout sample rate is not supported by the audio driver, then in step 425 a lower sample rate of the preferred sample rates from step 415 is selected, and the process returns to step 420 where the lower sample rate is evaluated for audio driver supportability. The sample rate selection algorithm illustrated in FIG. 4 selects the highest sample rates for recording and playout that are supported by the audio driver. As such, in at least the example embodiment illustrated in FIG. 4, if the playout sample rate selected in step 415 is determined in step 420 to be unsupported by the audio driver, then the process selects a lower preferred sample rate for playout in step 425. However, the lower preferred sample rate selected in step 425 is not tested again for supportability in recording audio, but instead is tested only for supportability in playout of audio in step 420. The algorithm aims to select the highest possible sample rates for each of the recording and playout functions, and therefore in at least some implementations the determinations as to audio driver supportability made in steps 405 and 420 of the process are independent of each other.

If the sample rate selected for audio playout in either of step 415 or 425 is determined to be supported by the audio driver in step 420, then the process moves to step 430 where the selected sample rates are stored (e.g., in memory 220 shown in FIG. 2) for use when the recording and playout functions are initiated.

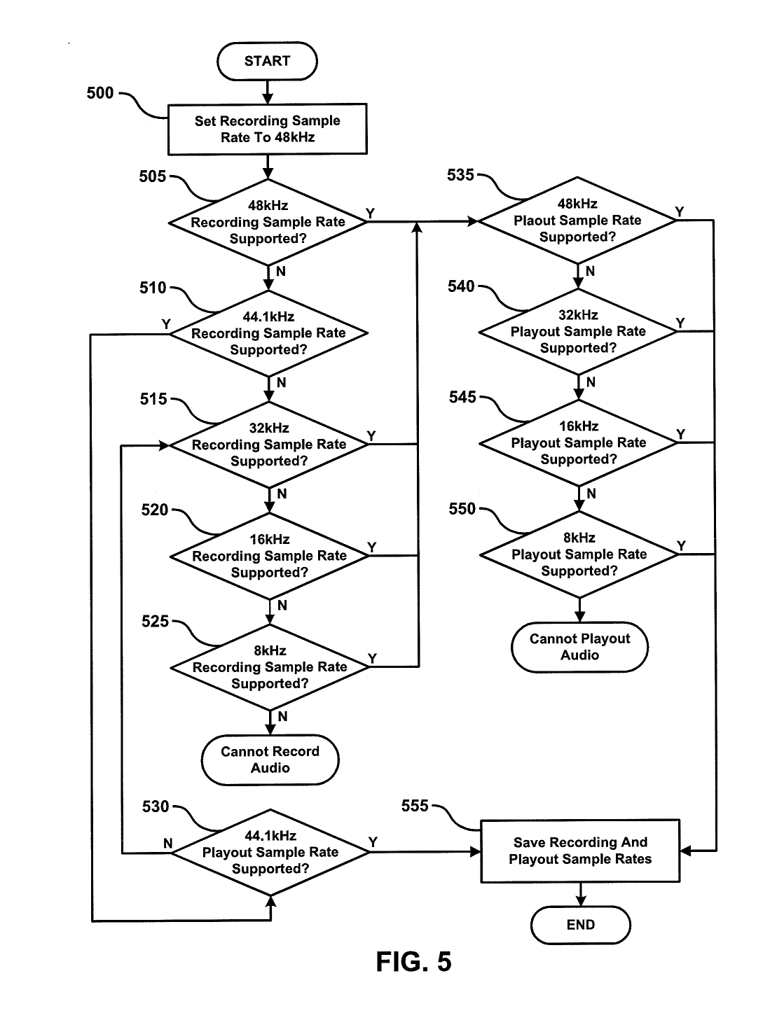

FIG. 5 illustrates an example method for selecting audio recording and playout sample rates for a particular set of preferred audio codecs according to one or more embodiments described herein. Other implementations may include various other sets of codecs different from those codecs for which the process shown may be used. In at least some embodiments of the disclosure, the sample rate selection algorithm illustrated in FIG. 5 selects a playout sample rate that is a multiple of 8 kHz when the selected recording sample rate is itself a multiple of 8 kHz. If the selected recording sample rate is not a multiple of 8 kHz, such as a rate of 44.1 kHz, then the algorithm selects a playout sample rate that is the same as the recording sample rate.

The process begins at step 500 with the recording sample rate being set to 48 kHz. In step 505, the algorithm determines whether a 48 kHz recording sample rate is supported by the audio driver (e.g., audio driver S/W 115 shown in FIG. 1). In at least one embodiment of the disclosure the determination of whether the audio driver supports a 48 kHz sample rate for recording may be made in step 505 by determining if an API of the audio driver returns an error indicating the rate is not supported. In other embodiments, an audio interface module (e.g., audio interface module 140 shown in FIG. 1) implementing the selection algorithm may query the API to determine whether the 48 kHz recording sample rate is supported. As will be described in greater detail below, the determination as to whether the audio driver supports a 48 kHz playout sample rate (step 535) may be made in a similar manner (e.g., by testing the 48 kHz playout rate using the API of the audio driver or having the audio interface module query the API as to whether a 48 kHz playout sample rate is supported).

If it is determined in step 505 that the audio driver does not support a 48 kHz recording sample rate, then in step 510 a 44.1 kHz sample rate for recording audio is set and tested for supportability by the audio driver. If it is found in step 510 that the audio driver also does not support a 44.1 kHz recording sample rate, then the process continues as necessary to steps 515, 520, and 525 where recording sample rates of 32 kHz, 16 kHz, and 8 kHz, respectively, are selected and tested for supportability.

In scenarios where it is determined in step 525 that the audio driver does not support a recording sample rate of 8 kHz, then the algorithm ends by concluding that audio data cannot be recorded on the particular audio device.

If in step 510 it is instead determined that a 44.1 kHz sample rate for recording audio is supported, then the process goes to step 530 where a determination is made as to whether a playout sample rate of 44.1 kHz is also supported. In at least the implementation illustrated in FIG. 5, if the highest supported recording sample rate is not a multiple of 8 kHz, such as a recording sample rate of 44.1 kHz, then the algorithm selects the playout sample rate to be the same (e.g., a playout sample rate of 44.1 kHz). If it is found in step 530 that the audio driver supports a playout sample rate of 44.1 kHz, then in step 555 both the recording and playout sample rates are set to 44.1 kHz and saved (e.g., in memory 220 shown in FIG. 2) until the recording and playout functions are called. On the other hand, if it is determined in step 530 that the audio driver does not support a playout sample rate of 44.1 kHz, then the process goes to step 515 where a 32 kHz sample rate for recording is tested for supportability. As described above, the sample rate selection algorithm as illustrated in the embodiment of FIG. 5 selects a playout sample rate that is a multiple of 8 kHz when the selected recording sample rate is a multiple of 8 kHz; and when the selected recording sample rate is not a multiple of 8 kHz (e.g., 44.1 kHz) the algorithm selects a playout sample rate that is the same as the recording sample rate. Accordingly, when it is found in step 530 that a 44.1 kHz playout sample rate is not supported, and therefore the playout sample rate is unable to be selected to be the same as the recording sample rate of 44.1 kHz, then process goes to step 515 where a 32 kHz sample rate is tested.

If, in any of steps 505, 515, 520, and 525 it is determined that a recording sample rate of 48 kHz, 32 kHz, 16 kHz, or 8 kHz, respectively, is supported by the audio driver, then the algorithm moves to step 535 where it is determined whether or not a playout sample rate of 48 kHz is supported. Once a recording sample rate is found to be supported in one of steps 505, 515, 520, and 525, the algorithm proceeds by determining whether a sample rate of the highest multiple of 8 kHz (e.g., 48 kHz) is supported for audio playout in step 535. If a 48 kHz playout sample rate is determined to be supported by the audio driver in step 535, then the process continues to step 555 where the selected recording and playout sample rates are saved. If instead it is determined in step 535 that a 48 kHz playout sample rate is not supported, then the algorithm continues to steps 540, 545 and 550 as necessary to determine a playout sample rate multiple of 8 kHz that is supported. When it is found in step 550 that an 8 kHz playout sample rate is not supported by the audio driver, then the selection algorithm concludes that the particular audio device is not able to playout audio data.

It should be noted that in any of the example implementations of a sample rate selection algorithm illustrated in FIGS. 3-5, and described in detail above, it is not necessary for the recording sample rate to be selected before the playout sample rate. Rather, in any of the various implementations of the sample rate selection algorithm, including those not illustrated in FIGS. 3-5, the playout sample rate may be selected before the recording sample rate.

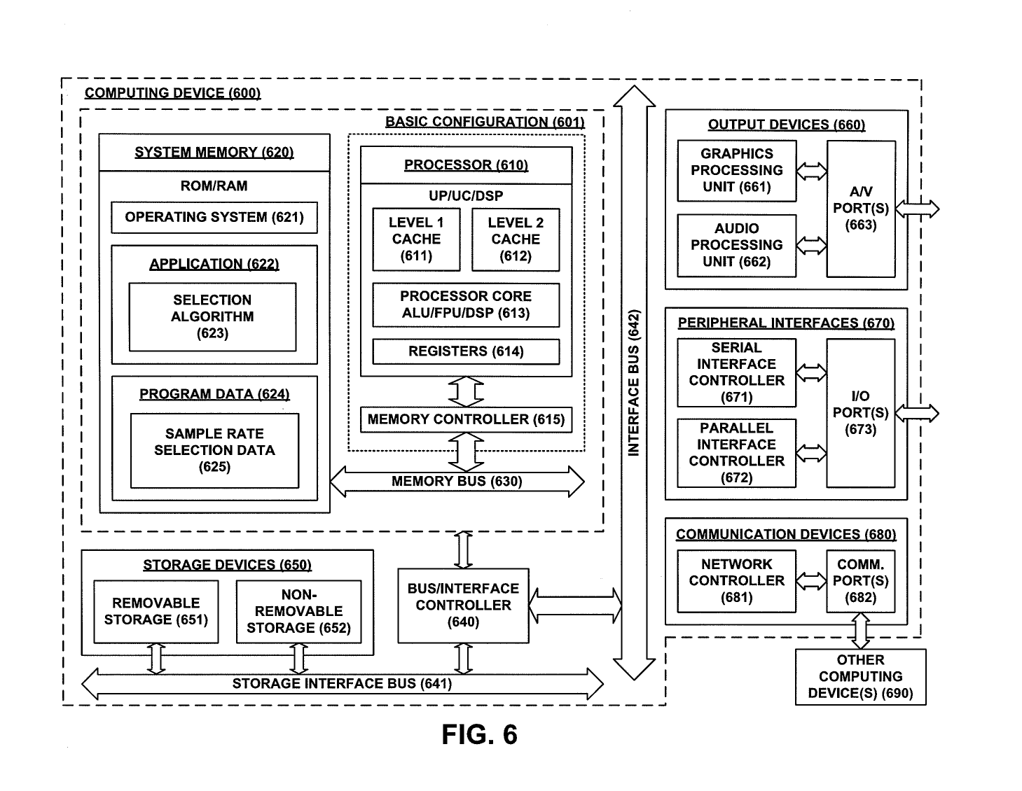

FIG. 6 is a block diagram illustrating an example computing device 600 that is arranged for multipath routing in accordance with one or more embodiments of the present disclosure. In a very basic configuration 601, computing device 600 typically includes one or more processors 610 and system memory 620. A memory bus 630 may be used for communicating between the processor 610 and the system memory 620.

Depending on the desired configuration, processor 610 can be of any type including but not limited to a microprocessor (μP), a microcontroller (μC), a digital signal processor (DSP), or any combination thereof. Processor 610 may include one or more levels of caching, such as a level one cache 611 and a level two cache 612, a processor core 613, and registers 614. The processor core 613 may include an arithmetic logic unit (ALU), a floating point unit (FPU), a digital signal processing core (DSP Core), or any combination thereof. A memory controller 615 can also be used with the processor 610, or in some embodiments the memory controller 615 can be an internal part of the processor 610.

Depending on the desired configuration, the system memory 620 can be of any type including but not limited to volatile memory (e.g., RAM), non-volatile memory (e.g., ROM, flash memory, etc.) or any combination thereof. System memory 620 typically includes an operating system 621 (which may be similar to audio device OS 180 shown in FIG. 1), one or more applications 622 (e.g., VoIP application 175 shown in FIG. 1), and program data 624. In at least some embodiments, application 622 includes a selection algorithm 623 that is configured to select recording and sample playout rates supportable by recording and playout devices built into or connected to computing device 600. The selection algorithm is further configured select the recording and playout sample rates such that audio processing components also operating within computing device 600 may perform under optimal conditions. Program Data 624 may include sample rate selection data 625 that is useful for identifying certain characteristics and capabilities of applicable audio devices used in conjunction with computing device 600 for audio recording and playout.

Computing device 600 can have additional features and/or functionality, and additional interfaces to facilitate communications between the basic configuration 601 and any required devices and interfaces. For example, a bus/interface controller 640 can be used to facilitate communications between the basic configuration 601 and one or more data storage devices 650 via a storage interface bus 641. The data storage devices 650 can be removable storage devices 651, non-removable storage devices 652, or any combination thereof. Examples of removable storage and non-removable storage devices include magnetic disk devices such as flexible disk drives and hard-disk drives (HDD), optical disk drives such as compact disk (CD) drives or digital versatile disk (DVD) drives, solid state drives (SSD), tape drives and the like. Example computer storage media can include volatile and nonvolatile, removable and non-removable media implemented in any method or technology for storage of information, such as computer readable instructions, data structures, program modules, and/or other data.

System memory 620, removable storage 651 and non-removable storage 652 are all examples of computer storage media. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by computing device 600. Any such computer storage media can be part of computing device 600.

Computing device 600 can also include an interface bus 642 for facilitating communication from various interface devices (e.g., output interfaces, peripheral interfaces, communication interfaces, etc.) to the basic configuration 601 via the bus/interface controller 640. Example output devices 660 include a graphics processing unit 661 and an audio processing unit 662, either or both of which can be configured to communicate to various external devices such as a display or speakers via one or more A/V ports 663. Example peripheral interfaces 670 include a serial interface controller 671 or a parallel interface controller 672, which can be configured to communicate with external devices such as input devices (e.g., keyboard, mouse, pen, voice input device, touch input device, etc.) or other peripheral devices (e.g., printer, scanner, etc.) via one or more I/O ports 673. An example communication device 680 includes a network controller 681, which can be arranged to facilitate communications with one or more other computing devices 690 over a network communication (not shown) via one or more communication ports 682. The communication connection is one example of a communication media. Communication media may typically be embodied by computer readable instructions, data structures, program modules, or other data in a modulated data signal, such as a carrier wave or other transport mechanism, and includes any information delivery media. A “modulated data signal” can be a signal that has one or more of its characteristics set or changed in such a manner as to encode information in the signal. By way of example, and not limitation, communication media can include wired media such as a wired network or direct-wired connection, and wireless media such as acoustic, radio frequency (RF), infrared (IR) and other wireless media. The term computer readable media as used herein can include both storage media and communication media.

Computing device 600 can be implemented as a portion of a small-form factor portable (or mobile) electronic device such as a cell phone, a personal data assistant (PDA), a personal media player device, a wireless web-watch device, a personal headset device, an application specific device, or a hybrid device that include any of the above functions. Computing device 600 can also be implemented as a personal computer including both laptop computer and non-laptop computer configurations.

There is little distinction left between hardware and software implementations of aspects of systems; the use of hardware or software is generally (but not always, in that in certain contexts the choice between hardware and software can become significant) a design choice representing cost versus efficiency tradeoffs. There are various vehicles by which processes and/or systems and/or other technologies described herein can be effected (e.g., hardware, software, and/or firmware), and the preferred vehicle will vary with the context in which the processes and/or systems and/or other technologies are deployed. For example, if an implementer determines that speed and accuracy are paramount, the implementer may opt for a mainly hardware and/or firmware vehicle; if flexibility is paramount, the implementer may opt for a mainly software implementation. In one or more other scenarios, the implementer may opt for some combination of hardware, software, and/or firmware.

The foregoing detailed description has set forth various embodiments of the devices and/or processes via the use of block diagrams, flowcharts, and/or examples. Insofar as such block diagrams, flowcharts, and/or examples contain one or more functions and/or operations, it will be understood by those within the art that each function and/or operation within such block diagrams, flowcharts, or examples can be implemented, individually and/or collectively, by a wide range of hardware, software, firmware, or virtually any combination thereof.

In one or more embodiments, several portions of the subject matter described herein may be implemented via Application Specific Integrated Circuits (ASICs), Field Programmable Gate Arrays (FPGAs), digital signal processors (DSPs), or other integrated formats. However, those skilled in the art will recognize that some aspects of the embodiments described herein, in whole or in part, can be equivalently implemented in integrated circuits, as one or more computer programs running on one or more computers (e.g., as one or more programs running on one or more computer systems), as one or more programs running on one or more processors (e.g., as one or more programs running on one or more microprocessors), as firmware, or as virtually any combination thereof. Those skilled in the art will further recognize that designing the circuitry and/or writing the code for the software and/or firmware would be well within the skill of one of skilled in the art in light of the present disclosure.

Additionally, those skilled in the art will appreciate that the mechanisms of the subject matter described herein are capable of being distributed as a program product in a variety of forms, and that an illustrative embodiment of the subject matter described herein applies regardless of the particular type of signal-bearing medium used to actually carry out the distribution. Examples of a signal-bearing medium include, but are not limited to, the following: a recordable-type medium such as a floppy disk, a hard disk drive, a Compact Disc (CD), a Digital Video Disk (DVD), a digital tape, a computer memory, etc.; and a transmission-type medium such as a digital and/or an analog communication medium (e.g., a fiber optic cable, a waveguide, a wired communications link, a wireless communication link, etc.).

Those skilled in the art will also recognize that it is common within the art to describe devices and/or processes in the fashion set forth herein, and thereafter use engineering practices to integrate such described devices and/or processes into data processing systems. That is, at least a portion of the devices and/or processes described herein can be integrated into a data processing system via a reasonable amount of experimentation. Those having skill in the art will recognize that a typical data processing system generally includes one or more of a system unit housing, a video display device, a memory such as volatile and non-volatile memory, processors such as microprocessors and digital signal processors, computational entities such as operating systems, drivers, graphical user interfaces, and applications programs, one or more interaction devices, such as a touch pad or screen, and/or control systems including feedback loops and control motors (e.g., feedback for sensing position and/or velocity; control motors for moving and/or adjusting components and/or quantities). A typical data processing system may be implemented utilizing any suitable commercially available components, such as those typically found in data computing/communication and/or network computing/communication systems.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

While various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following claims.

I claim:

1. A method for selecting sample rates for audio recording and playout on an audio device, comprising:
selecting a first recording sample rate of a plurality of recording sample rates for recording audio on the device;
determining the device supports the first recording sample rate; and
responsive to determining the device supports the first recording sample rate, selecting a playout sample rate based on the first recording sample rate.

2. The method of claim 1, wherein the selected playout sample rate is the same as the first recording sample rate.

3. The method of claim 1, wherein the selected playout sample rate is a multiple of the first recording sample rate.

4. The method of claim 1, wherein the playout sample rate is one of a plurality of playout sample rates, and wherein selecting the playout sample rate based on the first recording sample rate includes:
identifying one or more playout sample rates of the plurality of playout sample rates as a multiple of the first recording sample rate;
selecting a highest of the one or more identified playout sample rates; and
determining the device supports the highest of the one or more playout sample rates.

5. The method of claim 4, further comprising:
responsive to determining the device does not support the highest of the one or more playout sample rates, selecting a next highest playout sample rate of the one or more playout sample rates.

6. The method of claim 1, further comprising:
responsive to determining the device does not support the first recording sample rate, selecting a second recording sample rate of the plurality of recording sample rates, wherein the second recording sample rate is less than the first recording sample rate; and
responsive to determining the device supports the second recording sample rate, selecting a playout sample rate based on the second recording sample rate.

7. The method of claim 1, wherein selecting the playout sample rate based on the first recording sample rate includes:
determining whether the first recording sample rate is greater than or equal to a threshold sample rate;
responsive to determining the first recording sample rate is greater than or equal to the threshold sample rate, selecting a playout sample rate equal to the first recording sample rate; and
responsive to determining the first recording sample rate is not greater than or equal to the threshold sample rate, selecting a multiple of the first recording sample rate as the playout sample rate, wherein the multiple of the first recording sample rate is greater than or equal to the threshold sample rate.

8. The method of claim 7, wherein the threshold sample rate is one of 16 kHz and 32 kHz.

9. The method of claim 1, wherein each of the first recording sample rate and the selected playout sample rate is a multiple of 8 kHz.

10. A method for determining audio recording and playout sample rates comprising:
selecting a first recording sample rate of a plurality of recording sample rates for recording audio on an audio device;
determining whether the audio device supports the first recording sample rate;
responsive to determining the audio device supports the first recording sample rate, selecting a playout sample rate based on the first recording sample rate;
responsive to determining the audio device does not support the first recording sample rate, selecting a second recording sample rate of the plurality of recording sample rates, wherein the second recording sample rate is less than the first recording sample rate; and
responsive to determining the audio device supports the second recording sample rate, selecting the playout sample rate based on the second recording sample rate.

11. A system for selecting sample rates for audio recording and playout comprising:
an audio device configured to record audio using one or more of a plurality of recording sample rates and playout audio using one or more of a plurality of playout sample rates; and
an audio device driver in communication with the audio device, the audio device driver configured to:
select a first recording sample rate of the plurality of recording sample rates;
determine the audio device supports the first recording sample rate; and
in response to determining the audio device supports the first recording sample rate, select a playout sample rate of the plurality of playout sample rates based on the first recording sample rate.

12. The system of claim 11, further comprising:
an audio input device for capturing audio to be recorded on the audio device; and
an audio output device for playing audio recorded on the audio device.

13. The system of claim 11, wherein the audio device driver is further configured to:
select the first recording sample rate as the playout sample rate.

14. The system of claim 11, wherein the audio device driver is further configured to:
select a multiple of the first recording sample rate as the playout sample rate.

15. The system of claim 11, wherein the audio device driver is further configured to:
identify one or more of the plurality of playout sample rates as a multiple of the first recording sample rate;
select a highest of the one or more identified playout sample rates; and
determine the audio device supports the highest of the one or more identified playout sample rates.

16. The system of claim 15, wherein the audio device driver is further configured to:
in response to determining the audio device does not support the highest of the one or more identified playout sample rates, select a next highest playout sample rate of the one or more identified playout sample rates.

17. The system of claim 11, wherein the audio device driver is further configured to:
in response to determining the audio device does not support the first recording sample rate, select a second recording sample rate of the plurality of recording sample rates, wherein the second recording sample rate is less than the first recording sample rate; and
in response to determining the audio device supports the second recording sample rate, select a playout sample rate of the plurality of playout sample rates based on the second recording sample rate.

18. The system of claim 11, wherein the audio device driver is further configured to:
determine whether the first recording sample rate is greater than or equal to a threshold sample rate; and
in response to determining the first recording sample rate is not greater than or equal to the threshold sample rate, select a multiple of the first recording sample rate as the playout sample rate, wherein the multiple of the first recording sample rate is greater than or equal to the threshold sample rate.

19. The system of claim 18, wherein the threshold sample rate is one of 16 kHz and 32 kHz.

20. The system of claim 11, wherein each of the first recording sample rate and the selected playout sample rate is a multiple of 8 kHz.
